(19) United States
(12) Patent Application Publication
(10) Pub. No.: US 2025/0193902 A1
(43) Pub. Date: Jun. 12, 2025

(54) FLEXIBLE DISTRIBUTIONS OF MONITORING LOADS ACROSS CARRIERS ASSOCIATED WITH PHYSICAL DOWNLINK CONTROL CHANNEL MONITORING IN MULTI-CARRIER OPERATIONS

(71) Applicant: QUALCOMM Incorporated, San Diego, CA (US)

(72) Inventors: Kianoush HOSSEINI, San Diego, CA (US); Jing LEI, San Diego, CA (US); Kazuki TAKEDA, Minato-ku (JP)

(21) Appl. No.: 18/537,330

(22) Filed: Dec. 12, 2023

(51) Int. Cl. H04W 72/232; H04L 1/00; H04L 27/26; H04W 76/15

(52) U.S. Cl. CPC H04W 72/232; H04L 1/0038; H04L 27/26025; H04W 76/15

(57) ABSTRACT

Various aspects of the present disclosure generally relate to wireless communication. Various aspects relate generally to physical downlink control channel (PDCCH) monitoring distributions. Some aspects more specifically relate to flexible scheduling of blind decodes (BDs) and/or control channel elements (CCEs) for PDCCH monitoring in multi-carrier operations.

### FIELD OF THE DISCLOSURE

Aspects of the present disclosure generally relate to wireless communication and specifically relate to techniques, apparatuses, and methods associated with monitoring distributions associated with physical downlink control channel monitoring in multi-carrier operations.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

Aggregating a large number of carriers can be useful in realizing high throughput for a user equipment (UE). However, in multi-carrier operation, there can be a tradeoff between network scheduling flexibility and UE complexity. For example, in some cases, a network node can transmit a physical downlink control channel (PDCCH) (e.g., including control information, such as downlink control information) based at least in part on a search space set. A given search space set defines candidates that may carry a PDCCH within the search space set, where each candidate is associated with one or more control channel elements (CCEs). A CCE may be composed of multiple resource element groups (REGs). An REG may include one resource block and one orthogonal frequency division multiplexing (OFDM) symbol. One or more search space sets may be associated with a control resource set (CORESET). In some cases, a network node may flexibly schedule and transmit the PDCCH. In other words, transmission of the PDCCH may not be limited to a particular set of frequency resources and/or time resources in a given radio frame. PDCCH frequency domain and time domain resources can be configured on a per CORESET basis. Thus, once a UE is configured with a CORESET, the UE has information that identifies which resource blocks in the frequency domain are assigned to a search space set associated with the CORESET, as well as information that identifies a number of consecutive symbols occupied by the search space set. In some cases, when a UE is operating in a multi-carrier mode, (e.g., either in carrier aggregation (CA) mode or dual connectivity (DC) mode), a UE can be expected to blindly decode a number of PDCCH candidates, M, over a number of non-overlapped CCEs, C. In some cases, if different subcarrier spacings (SCSs) are supported, these numbers can be SCS dependent. However, in order to balance the processing load on the UE operating in a multi-carrier mode, these numbers are adjustable.

### SUMMARY

Some aspects described herein relate to a user equipment (UE) for wireless communication. The user equipment may include one or more memories storing processor readable code and one or more processors coupled with the one or more memories. The one or more processors may be individually or collectively configured to cause the UE to communicate monitoring distribution information associated with physical downlink control channel (PDCCH) monitoring in a multi-carrier mode, the monitoring distribution information indicative of at least one of a distribution of a plurality of blind decodes (BDs) or a distribution of a plurality of control channel elements (CCEs) associated with monitoring PDCCH candidates across a plurality of carriers. The one or more processors may be individually or collectively operable to cause the user equipment to monitor the PDCCH candidates in accordance with the at least one of the distribution of the plurality of BDs or the distribution of the plurality CCEs.

Some aspects described herein relate to a network node for wireless communication. The network node may include one or more memories storing processor readable code and one or more processors coupled with the one or more memories. The one or more processors may be individually or collectively configured to cause the network node to communicate monitoring distribution information associated with PDCCH monitoring in a multi-carrier mode, the monitoring distribution information indicative of at least one of a distribution of a plurality of blind decodes (BDs) or a distribution of a plurality of control channel elements (CCEs) associated with monitoring PDCCH candidates across a plurality of carriers. The one or more processors may be individually or collectively operable to cause the network node to transmit downlink control information (DCI) in accordance with the monitoring distribution information.

Some aspects described herein relate to a method for wireless communication by a UE. The method may include communicating monitoring distribution information associated with PDCCH monitoring in a multi-carrier mode, the monitoring distribution information indicative of at least one of a distribution of a plurality of blind decodes (BDs) or a distribution of a plurality of control channel elements (CCEs) associated with monitoring PDCCH candidates across a plurality of carriers. The method may include monitoring the PDCCH candidates in accordance with the at least one of the distribution of the plurality of BDs or the distribution of the plurality CCEs.

Some aspects described herein relate to a method of wireless communication by a network node. The method may include communicating monitoring distribution information associated with PDCCH monitoring in a multi-carrier mode, the monitoring distribution information indicative of at least one of a distribution of a plurality of blind decodes (BDs) or a distribution of a plurality of control channel elements (CCEs) associated with monitoring PDCCH candidates across a plurality of carriers. The method may include transmitting DCI in accordance with the monitoring distribution information.

Some aspects described herein relate to a non-transitory computer-readable medium that stores a set of instructions for wireless communication by a UE. The set of instructions, when executed by one or more processors of the UE, may cause the UE to communicate monitoring distribution information associated with PDCCH monitoring in a multi-carrier mode, the monitoring distribution information indicative of at least one of a distribution of a plurality of blind decodes (BDs) or a distribution of a plurality of control channel elements (CCEs) associated with monitoring PDCCH candidates across a plurality of carriers. The set of instructions, when executed by one or more processors of the UE, may cause the UE to monitor the PDCCH candidates in accordance with the at least one of the distribution of the plurality of BDs or the distribution of the plurality CCEs.

Some aspects described herein relate to a non-transitory computer-readable medium that stores a set of instructions for wireless communication by a network node. The set of instructions, when executed by one or more processors of the network node, may cause the network node to communicate monitoring distribution information associated with PDCCH monitoring in a multi-carrier mode, the monitoring distribution information indicative of at least one of a distribution of a plurality of blind decodes (BDs) or a distribution of a plurality of control channel elements (CCEs) associated with monitoring PDCCH candidates across a plurality of carriers. The set of instructions, when executed by one or more processors of the network node, may cause the network node to transmit DCI in accordance with the monitoring distribution information.

Some aspects described herein relate to an apparatus for wireless communication. The apparatus may include means for communicating monitoring distribution information associated with PDCCH monitoring in a multi-carrier mode, the monitoring distribution information indicative of at least one of a distribution of a plurality of blind decodes (BDs) or a distribution of a plurality of control channel elements (CCEs) associated with monitoring PDCCH candidates across a plurality of carriers. The apparatus may include means for monitoring the PDCCH candidates in accordance with the at least one of the distribution of the plurality of BDs or the distribution of the plurality CCEs.

Some aspects described herein relate to an apparatus for wireless communication. The apparatus may include means for communicating monitoring distribution information associated with PDCCH monitoring in a multi-carrier mode, the monitoring distribution information indicative of at least one of a distribution of a plurality of blind decodes (BDs) or a distribution of a plurality of control channel elements (CCEs) associated with monitoring PDCCH candidates across a plurality of carriers. The apparatus may include means for transmitting DCI in accordance with the monitoring distribution information.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4 is a diagram illustrating an example associated with monitoring distributions associated with physical downlink control channel (PDCCH) monitoring in multi-carrier operations, in accordance with the present disclosure.

FIG. 5 is a flowchart illustrating an example process performed, for example, at a UE or an apparatus of a UE that supports multi-carrier operations in accordance with the present disclosure.

FIG. 6 is a flowchart illustrating an example process performed, for example, at a network node or an apparatus of a network node that supports multi-carrier operations in accordance with the present disclosure.

FIG. 7 is a diagram of an example apparatus for wireless communication that supports multi-carrier operations in accordance with the present disclosure.

FIG. 8 is a diagram of an example apparatus for wireless communication that supports multi-carrier operations in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some cases, a network node transmits a physical downlink control channel (PDCCH) based at least in part on a search space set. A given search space set defines candidates that may carry a PDCCH, where each candidate is associated with one or more control channel elements (CCEs) within the search space set. A CCE may be composed of multiple resource element groups (REGs). An REG may include one resource block and one OFDM symbol. A search space set may be UE-specific (e.g., a search space set that may carry control information specific to one or more particular UEs). One or more search space sets may be associated with a control resource set (CORESET). In this manner, a network node may flexibly schedule and transmit the PDCCH to a particular UE. In other words, transmission of the PDCCH may not be limited to a particular set of frequency resources and/or time resources in a given radio frame. PDCCH frequency domain and time domain resources can be configured on a per CORESET basis. Thus, once a UE is configured with a CORESET, the UE has information that identifies which resource blocks in the frequency domain are assigned to a search space set associated with the CORESET, as well as information that identifies a number of consecutive symbols occupied by the search space set. To receive a PDCCH associated with one or more candidates of a given UE-specific search space set, a UE attempts to decode a PDCCH in candidates of the search space set. For example, the UE may determine one or more CCE indices associated with a candidate, and may attempt to decode the PDCCH (e.g., using a blind decoding (BD) procedure).

In some cases, when a UE is operating in a multi-carrier mode, such as a carrier aggregation (CA) mode or a dual connectivity (DC) mode, the UE is not expected to blindly decode more than a particular number of PDCCH candidates, M, over a number of non-overlapping CCEs, C. Maximum values of M and C. M_{PDCCH}^{max,slot} and C_{PDCCH}^{max,slot}, respectively, are specified on a per-serving-cell basis. In some cases, the values M_{PDCCH}^{max,slot} and C_{PDCCH}^{max,slot} are subcarrier spacing (SCS) dependent. In some cases, to balance the processing load on UEs operating in a multi-carrier mode, the values M_{PDCCH}^{max,slot} and C_{PDCCH}^{max,slot} may be adjustable. For example, in a CA mode, a UE may report, as part of UE capability information, a value of a parameter pdcch-BlindDetectionCA, which may indicate a number of cells over which a linear scaling factor associated with the values of M_{PDCCH}^{max,slot} and C_{PDCCH}^{max,slot} is to be applied. In the CA mode, when the number of cells configured for the UE across all SCSs is greater than the value of the parameter pdcch-BlindDetectionCA, PDCCH monitoring rules may require that the values of M_{PDCCH}^{max,slot} max,slot and C_{PDCCH}^{max,slot} are scaled so that the number of PDCCH candidates to be monitored is distributed across the carriers and that distribution is specified according to the SCS of each carrier. In dual connectivity, similar rules may apply, but are applied at the per-cell-group level rather than the per-cell level.

The rigidity of these rules may result in PDCCH monitoring distributions that are less desirable. For example, in cases in which a UE is configured in CA mode with four component carriers (CCs) in FR1 with SCS=30 kHz and four CCs in FR2 with SCS=120 kHz, if the value of the pdcch-BlindDetectionCA parameter is 4, then the total number of BDs across the FR1 CCs is 2*M_{PDCCH}^{max,slot}, which are to be distributed across the four FR1 carriers. The same would be true for the FR2 carriers. However, in some cases, a network node may benefit from flexibility with regard to the PDCCH load distribution. For example, to support scheduling schemes or to improve the chances of successful control transmissions on FR1 carriers versus control transmissions on FR2 carriers, it may be beneficial to move more of the PDCCH load to the FR1 carriers. Similarly, in some cases, monitoring FR2 carriers may consume more power and/or computing resources at the UE than monitoring FR1 carriers and, therefore, it may be beneficial to UEs to move more of the PDCCH monitoring load to the FR1 carriers. Thus, flexibility associated with PDCCH load distribution may be beneficial to the network and/or the UE. Therefore, it can be beneficial to split the CCEs and/or BDs across carriers with different PDCCH monitoring capabilities (e.g., slot-based versus span-based), different SCSs, and/or different span patterns.

Various aspects relate generally to monitoring PDCCH candidates in association with PDCCH monitoring distributions. Some aspects more specifically relate to enabling flexibility in distributing PDCCH monitoring loads across carriers in multi-carrier operations. For example, some aspects may relate to flexible distribution of BDs and/or CCEs across carriers for PDCCH monitoring while operating in a multi-carrier mode. In some aspects, for a UE operating in a multi-carrier mode (e.g., CA or DC), the number of BDs and/or CCEs for PDCCH monitoring may be controlled by a network node and/or in association with a request from the UE. For example, a network node may indicate a distribution of BDs and/or a distribution of CCEs to a UE explicitly or implicitly. For example, in some examples, the network node may explicitly indicate the number of BDs and/or CCEs for each carrier or group of carriers. In some other examples, the network node may indicate a scaling factor that the UE is to apply when determining the number of BDs and/or CCEs for each carrier. In some examples, the indication of the number of BDs and/or CCEs may be CC-specific, band-specific, SCS-specific, and/or FR-specific. In some examples, the indication of the number of BDs and/or CCEs may be associated with a UE capability such as, for example, a total number of BDs and/or CCEs that the UE can support across all configured carriers, all configured carriers in a cell group, carriers in a group of carriers, and/or per carrier.

Particular aspects of the subject matter described in this disclosure can be implemented to realize one or more of the following potential advantages. In some examples, the described techniques can be used to introduce flexibility in PDCCH BD/CCE distribution, which may enable more efficient resource allocation by network nodes and/or power consumption by UEs. By indicating the number of BDs and/or CCEs, some aspects may enable a network to have more flexibility in control channel scheduling. In examples in which the number of BDs and/or CCEs are indicated implicitly, some aspects may enable the flexibility with a minimal increase in signalling overhead and/or computational complexity. Additionally or alternatively, by indicating the number of BDs and/or CCEs associated with specific CCs, bands, SCSs, and/or FRs, some aspects may enable increased granularity of control, by the network, over the flexible distribution of BDs and/or CCEs among carriers. Additionally or alternatively, by indicating the number of BDs and/or CCEs in association with a UE capability, some aspects may provide for improvements in flexibility that are tailored to a UE's capability for such flexibility, which may enable improved flexibility to the extent supportable by a UE without impairing operability of UEs with different capabilities.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

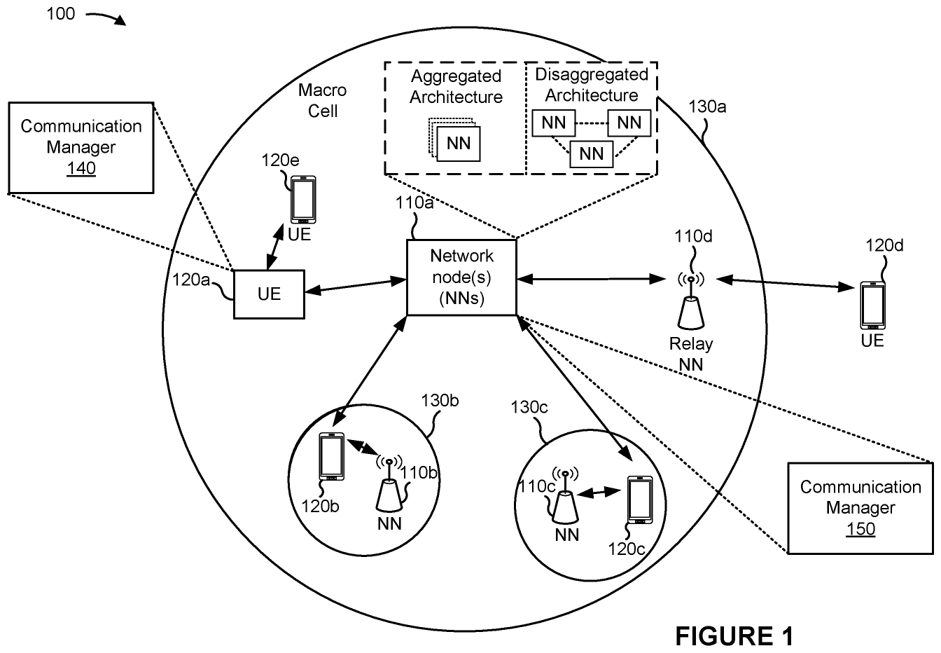

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular radio access technology (RAT) (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHZ), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a non-terrestrial network (NTN) network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As indicated above, a BWP may be configured as a subset or a part of a total or full component carrier bandwidth and generally forms or encompasses a set of contiguous common resource blocks (CRBs) within the full component carrier bandwidth. In other words, within the carrier bandwidth, a BWP starts at a CRB and may span a set of consecutive CRBs. Each BWP may be associated with its own numerology (indicating a sub-carrier spacing (SCS) and cyclic prefix (CP)). A UE 120 may be configured with up to four downlink BWPs and up to four uplink BWPs for each serving cell. To enable reasonable UE battery consumption, only one BWP in the downlink and one BWP in the uplink are generally active at a given time on an active serving cell under typical operation. The active BWP defines the operating bandwidth of the UE 120 within the operating bandwidth of the serving cell while all other BWPs with which the UE 120 is configured are deactivated. On deactivated BWPs, the UE 120 does not transmit or receive any communications.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an extended reality (XR) device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 and/or the network node 110 may include or may be included in a housing that houses components associated with the UE 120 and/or the network node 110, respectively, including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an unmanned aerial vehicle or drone, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of ultra-reliable low-latency communication (URLLC), enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some radio access technologies (RATs) may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may communicate monitoring distribution information associated with PDCCH monitoring in a multi-carrier mode, the monitoring distribution information indicative of at least one of a distribution of a plurality of blind decodes (BDs) or a distribution of a plurality of control channel elements (CCEs) associated with monitoring PDCCH candidates across a plurality of carriers; and monitor the PDCCH candidates in accordance with the at least one of the distribution of the plurality of BDs or the distribution of the plurality CCEs. Additionally, or alternatively, the communication manager 140 may perform one or more other operations described herein.

In some aspects, the network node 110 may include a communication manager 150. As described in more detail elsewhere herein, the communication manager 150 may communicate monitoring distribution information associated with PDCCH monitoring in a multi-carrier mode, the monitoring distribution information indicative of at least one of a distribution of a plurality of blind decodes (BDs) or a distribution of a plurality of control channel elements (CCEs) associated with monitoring PDCCH candidates across a plurality of carriers; and transmit downlink control information (DCI) in accordance with the monitoring distribution information. Additionally, or alternatively, the communication manager 150 may perform one or more other operations described herein.

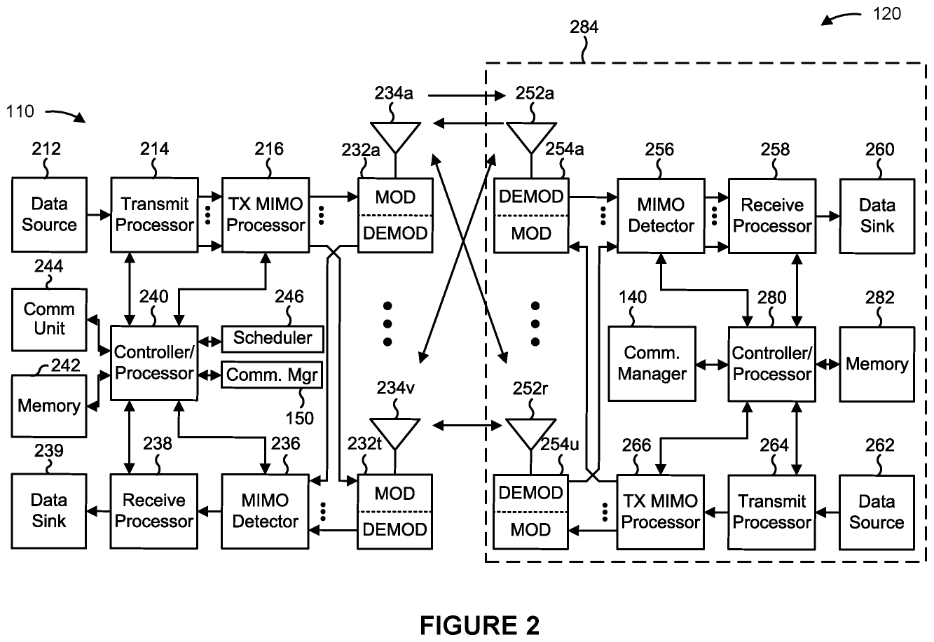

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a channel quality indicator (CQI) parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink SRS, and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

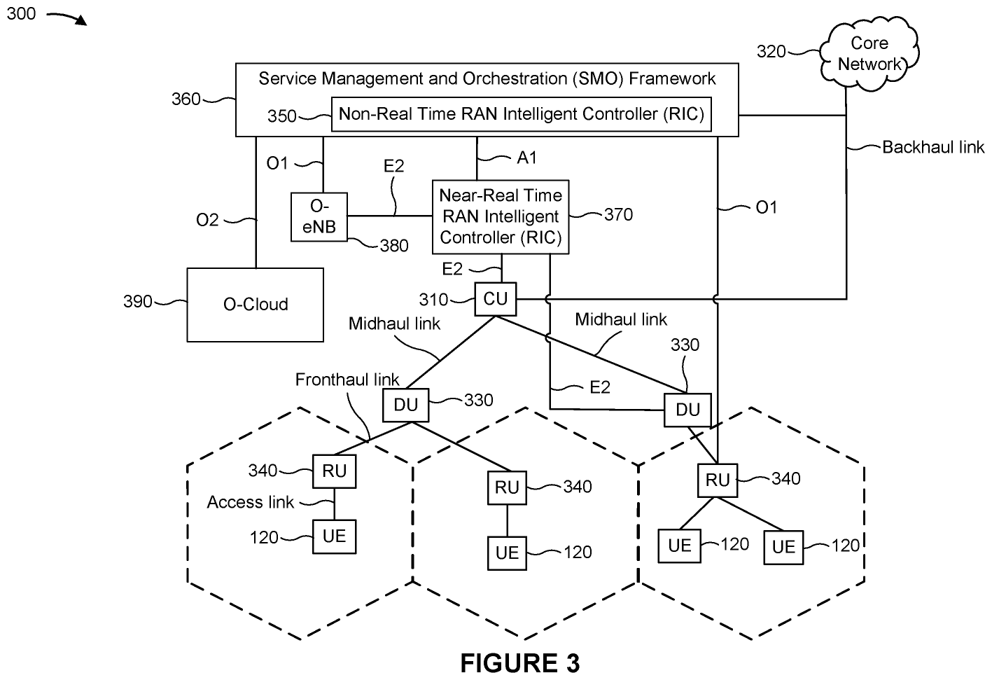

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 325 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU-UP units and one or more CU-CP units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, artificial intelligence and/or machine learning (AI/ML) workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

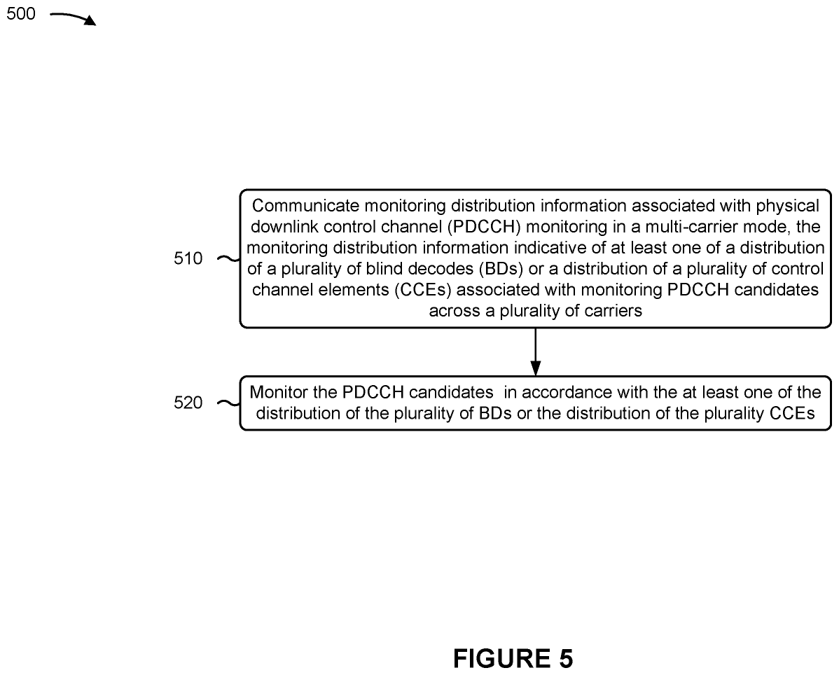

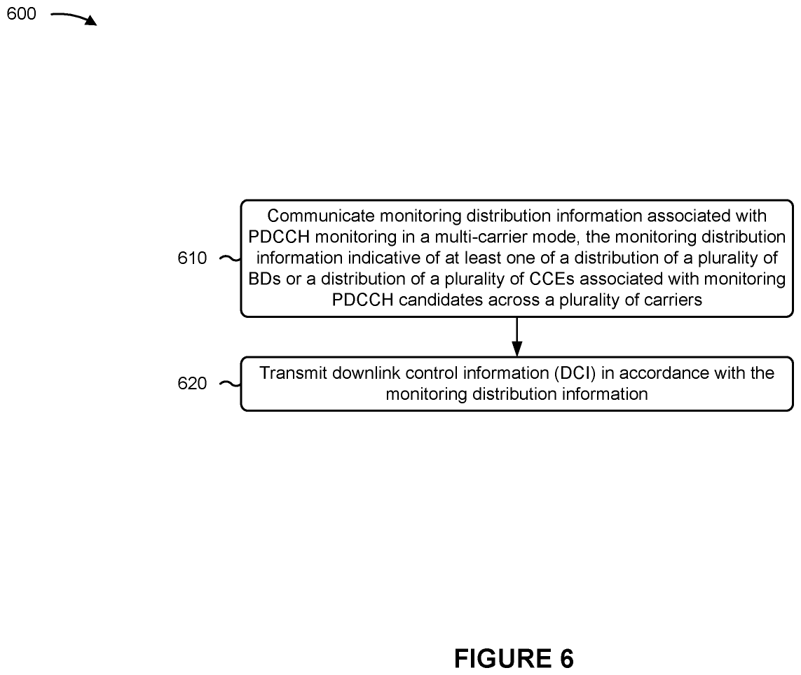

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with monitoring distributions associated with PDCCH monitoring in multi-carrier operations, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 500 of FIG. 5, process 600 of FIG. 6, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 500 of FIG. 5, process 600 of FIG. 6, or other processes as described herein. In some examples, executing instructions may include running the instructions, converting the instructions, compiling the instructions, and/or interpreting the instructions, among other examples.

In some aspects, a UE (e.g., the UE 120) includes means for communicating monitoring distribution information associated with PDCCH monitoring in a multi-carrier mode, the monitoring distribution information indicative of at least one of a distribution of a plurality of blind decodes (BDs) or a distribution of a plurality of control channel elements (CCEs) associated with monitoring PDCCH candidates across a plurality of carriers; and/or means for monitoring the PDCCH candidates in accordance with the at least one of the distribution of the plurality of BDs or the distribution of the plurality CCEs. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for communicating monitoring distribution information associated with PDCCH monitoring in a multi-carrier mode, the monitoring distribution information indicative of at least one of a distribution of a plurality of blind decodes (BDs) or a distribution of a plurality of control channel elements (CCEs) associated with monitoring PDCCH candidates across a plurality of carriers; and/or means for transmitting DCI in accordance with the monitoring distribution information. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

In some cases, a network node transmits a PDCCH (e.g., including control information, such as DCI) based at least in part on a search space set. A given search space set defines candidates that may carry a PDCCH within the search space set, where each candidate is associated with one or more CCEs. A CCE may be composed of multiple resource element groups (REGs). An REG may include one resource block and one OFDM symbol. One or more search space sets may be associated with a control resource set (CORESET). In some cases, a network node may flexibly schedule and transmit the PDCCH. In other words, transmission of the PDCCH may not be limited to a particular set of frequency resources and/or time resources in a given radio frame. PDCCH frequency domain and time domain resources can be configured on a per CORESET basis. Thus, once a UE is configured with a CORESET, the UE has information that identifies which resource blocks in the frequency domain are assigned to a search space set associated with the CORESET, as well as information that identifies a number of consecutive symbols occupied by the search space set.

To receive a PDCCH associated with one or more candidates of a given UE-specific search space set (e.g., a search space set that may carry control information specific to one or more particular UEs), a UE may attempt to decode a PDCCH in candidates of the search space set. For example, the UE may determine one or more CCE indices associated with a candidate, and may attempt to decode the PDCCH (e.g., using a BD procedure). In some cases, limits on the number of non-overlapping CCEs and BDs can be defined on a per-slot basis. Thus, a large number of CCEs/BDs can be configured within one span. A slot can include multiple spans, and a span can include one or more PDCCH candidates. This can increase the UE complexity, particularly when attempting to conform to processing timelines that are suitable for supporting URLLC applications. On the other hand, if the scheduling network node chooses to distribute the CCEs/BDs across different spans, the number of CCE/BDs per span may not be sufficient. For example, for a subcarrier spacing (SCS) of 30 kilohertz (kHz) and a span capability of (X,Y)=(2,2), each span can have 8 CCEs. Hence, only one candidate of aggregation level=8 can be supported.

In some cases, a PDCCH monitoring capability can be introduced that is based at least in part on a span configuration of the UE. To relax the UE complexity, a per-span CCE/BD limit (also referred to as a per-span capability) can be specified. This PDCCH monitoring capability can be referred to herein as a span-based monitoring capability, whereas the PDCCH monitoring capability defined on a per-slot basis may be referred to as a slot-based monitoring capability.

In some cases, when a UE is operating in a multi-carrier mode, (e.g., either in carrier aggregation (CA) mode or dual connectivity (DC) mode), a UE can be expected to blindly decode a number of PDCCH candidates, M, over a number of non-overlapped CCEs, C. The values for M_{PDCCH}^{max,slot} and C_{PDCCH}^{max,slot} can be specified on a per serving cell basis. In some cases, if different SCSs are supported, these numbers can be SCS dependent. However, in order to balance the processing load on the UE operating in a multi-carrier mode, these numbers are adjustable. For example, a UE can report a value via a parameter pdcch-BlindDetectionCA \in {x_min, . . . , x_max}, where x_min>=specified threshold, e.g., 4. The reported value by a UE may be denoted by N_{cells}^{cap}.

In some cases, if a UE indicates a CA capability larger than four serving cells, the UE can include, in capability information, an indication for a maximum number of PDCCH candidates the UE can monitor per slot when the UE is configured for CA operation over more than four cells. When the UE is not configured for DC operation, the UE can determine a capability to monitor a maximum number of PDCCH candidates per slot that corresponds to N_{cells}^{cap} downlink cells, where N_{cells}^{cap} is the number of configured downlink cells if the UE does not provide pdcch-BlindDetectionCA and, otherwise, N_{cells}^{cap} is the value of pdcch-BlindDetectionCA.

In some cases, the UE may be configured with a number of carriers that exceeds the threshold identified by the PDCCH monitoring capability. For example, if the UE is configured with PDCCHs across different carriers, and if the number of DL carriers exceeds the UE's capability for monitoring PDCCHs, the number of non-overlapped CCEs to be received or BDs to be performed may exceed the UE's capabilities on one or more carriers. Therefore, it can be beneficial to split the CCEs and/or BDs across carriers with different PDCCH monitoring capabilities (e.g., slot-based versus span-based), different SCSs, and/or different span patterns.

In some aspects, this distribution may be performed separately for a set of carriers associated with carriers for which there is no scaling associated with different SCSs, and for a set of carriers associated with scaling with weights across carriers for different SCSs. In some cases, the value N_{cells}^{cap} may represent the number of CCs for which the UE can perform slot-based monitoring, and the distribution of BDs (e.g., represented by M in the following equations) and non-overlapped CCEs (e.g., represented by C in the following equations) may be determined as follows:
If a UE is configured with N_{cells}^{DL,μ} downlink cells with DL bandwidth parts (BWPs) having SCS configuration μ where Σ_{μ=0}³N_{cells}^{DL,μ}≤N_{cells}^{cap}, the UE is not required to monitor, on the active DL BWP of the scheduling cell, more than M_{PDCCH}^{total,slot,μ}=M_{PDCH}^{max,slot,μ} PDCCH candidates or more than C_{PDCCH}^{total,slot,μ}=C_{PDCCH}^{max,slot,μ} non-overlapped CCEs per slot for each scheduled cell.
If a UE is configured with N_{cells}^{DL,μ} downlink cells with DL BWPs having SCS configuration μ, where Σ_{μ=0}³N_{cells}^{DL,μ}>N_{cells}^{cap}, a DL BWP of an activated cell is the active DL BWP of the activated cell, and a DL BWP of a deactivated cell is the DL BWP with index provided by firstActiveDownlinkBWP-Id for the deactivated cell, the UE is not required to monitor more than M_{PDCCH}^{total,slot,μ}=└N_{cells}^{cap}·M_{PDCCH}^{max,slot,μ}·N_{cells}^{DL,μ}/Σⱼ₌₀³N_{cells}^{DL,j}┘ PDCCH candidates or more than C_{PDCCH}^{total,slot,μ}=└N_{cells}^{cap}·C_{PDCCH}^{max,slot,μ}·N_{cells}^{DL,μ}/Σⱼ₌₀³N_{cells}^{DL,j}┘ non-overlapped CCEs per slot on the active DL BWP(s) of scheduling cell(s) from the N_{cells}^{DL,μ} downlink cells.
For each scheduled cell, the UE is not required to monitor on the active DL BWP with SCS configuration u of the scheduling cell more than min(M_{PDCCH}^{max,slot,μ},M_{PDCCH}^{total,slot,μ}) PDCCH candidates or more than min(C_{PDCCH}^{max,slot,μ}, C_{PDCCH}^{total,slot,μ}) non-overlapped CCEs per slot.

For example, when a UE is configured with more number of carriers than it has indicated by pdcch-BlindDetectionCA for PDCCH monitoring, the distribution of PDCCH across cells may be only determined by the number of CCs of every specific SCS. In some cases, neither the network nor the UE has any control on PDCCH configuration.

In some cases, a UE may be configured to operate in a dual connectivity (DC) mode (e.g., a multi-RAT dual connectivity mode), such as an NR dual connectivity (NR-DC) mode. The UE may operate in the dual connectivity mode using an MCG (e.g., one or more cells for anchoring a network connection between the UE and a core network) and an SCG (e.g., one or more additional cells to increase throughput).

In some cases, when a UE is configured for NR-DC operation, the UE can determine a capability to monitor a maximum number of PDCCH candidates per slot that corresponds to N_{cells}^{cap}=N_{cells}^{MCG} downlink cells for the MCG where N_{cells}^{MCG} is provided by pdcch-BlindDetection for the MCG (e.g., pdcch-BlindDetectionMCG) and can determine a capability to monitor a maximum number of PDCCH candidates per slot that corresponds to N_{cells}^{cap}=N_{cells}^{SCG} downlink cells for the SCG where N_{cells}^{SCG} is provided by pdcch-BlindDetection for the SCG (e.g., pdcch-BlindDetectionSCG). When the UE is configured for CA operation over more than four cells, or for a cell group when the UE is configured for NR-DC operation, the UE may not expect to monitor per slot a number of PDCCH candidates that is larger than the maximum number as derived from the corresponding value of N_{cells}^{cap} cells. Once N_{cells}^{cap} is determined for each CG, the determination of the distribution of CCEs and/or BDs is performed similar to the CA case.

For example, for NR-DC operation, a UE may indicate, through pdcch-BlindDetectionMCG-UE and pdcch-BlindDetectionSCG-UE, respective maximum values for pdcch-BlindDetection for the MCG and pdcch-BlindDetection for the SCG. If the UE reports a PDCCH monitoring capability value for carrier aggregation, pdcch-BlindDetectionCA, the UE may determine an MCG capability value, or an SCG capability value, that is less than the CA capability value (e.g., pdcch-BlindDetectionMCG-UE or pdcch-BlindDetectionSCG-UE has a value in a range of [1, . . . , pdcch-BlindDetectionCA−1]). In this case, a sum of the MCG capability value and the SCG capability value may be greater than, or equal to, the CA capability value. Otherwise, if N_{NR-DC,max}^{DL,cells} is a maximum total number of downlink cells that the UE can be configured on both the MCG and the SCG for NR-DC as indicated in UE capability information, the value range of the MCG capability value or the SCG capability value is [1, 2, 3]. In this case, a sum of the MCG capability value and the SCG capability value may be greater than, or equal to, the maximum total quantity of downlink cells that can be configured, for the UE (e.g., N_{NR-DC,max}^{DL,cells}).

Aggregating large number of carriers in the form of CA or DC can be useful in realizing high throughput for a UE. However, as illustrated in the discussion above, in multi-carrier operation, there can be a tradeoff between network scheduling flexibility and UE complexity. As an example, consider a case where a UE is configured in CA mode as follows:
4 CCs in FR1 with SCS=30 KHz (u=1)
4 CCs in FR2 with SCS=120 KHz (u=3)
pdcch-BlindDetectionCA=4
   Based on the techniques described above, the total number of BDs across FR1 carriers is 2*M_{PDCCH}^{max,slot,30 KHz}. These number of BDs, which is equal to 2 CCs worth of BDs, is to be PDCCH distributed across four FR1 carriers. The same may apply to the FR2 carriers. The lack of flexibility in this distribution can impair scheduling flexibility of the network and can result in larger UE power consumption due to complexity.

Some aspects of the techniques described herein may include flexible scheduling of BDs and/or CCEs for PDCCH monitoring in multi-carrier operations. In some aspects, for a UE operating in a multi-carrier mode (e.g., CA or DC), the number of BDs and/or CCEs for PDCCH monitoring may be controlled by a network node and/or in association with a request from the UE. In some aspects, the distribution may be indicated to a UE dynamically or semi-statically. In some aspects, the distribution may be indicated implicitly and/or explicitly.

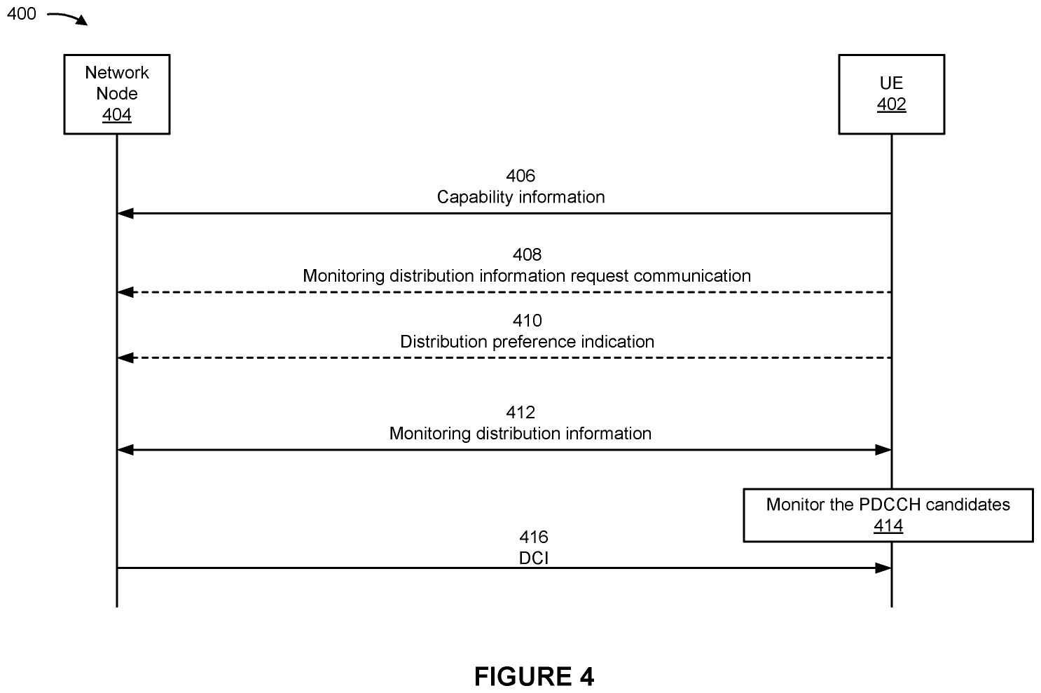

FIG. 4 is a diagram illustrating an example 400 associated with monitoring distributions associated with PDCCH monitoring in multi-carrier operations, in accordance with the present disclosure. As shown, a UE 402 and a network node 404 may communicate with one another. In some aspects, the UE 402 may be, be similar to, include, or be included in, the UE 120 depicted in FIGS. 1-3. In some aspects, the network node 404 may be, be similar to, include, or be included in, the network node 110 depicted in FIGS. 1 and 2, and/or one or more components of the disaggregated base station architecture 300 depicted in FIG. 3.

As shown in a first operation 406, the UE 402 may transmit, and the network node 404 may receive, capability information. In some aspects, the capability information may be indicative of a UE capability associated with a distribution of BDs and/or CCEs. In some aspects, the capability information may indicate a total quantity of BDs and/or CCEs supported by the UE 402. In some aspects, the total quantity may be associated with a set of configured carriers, a subset of the set of configured carriers, a cell group, and/or a carrier of the set of configured carriers, among other examples. In some aspects, the UE capability may be associated with one or more component carriers, bands, SCSs, and/or frequency ranges, among other examples. For example, the capability information may be separated across multi-carrier modes. In this example, the UE 402 may transmit capability information specific to a multi-carrier mode (such as carrier aggregation, dual-connectivity, or dual-stack), or may transmit capability information corresponding to each of multiple multi-carrier modes. In dual-stack (DS), a UE 402 may be connected to different RATs (such as 5G on a first set of component carriers and 6G on a second set of component carriers), and each RAT of the different RATs may be associated with a different core or protocol stack of the UE 402. For example, the UE 402 may include a 5G protocol stack which may handle communications on a first set of component carriers, and a 6G protocol stack which may handle communications on a second set of component carriers.

As shown in a second operation 408, the UE 402 may transmit, and the network node 404 may receive, a monitoring distribution information request communication. As shown in a third operation 410, the UE 402 may transmit, and the network node 404 may receive, a distribution preference indication. In some aspects, the distribution preference indication may be transmitted via UE assistance information (UAI) including the distribution preference indication.

As shown in a fourth operation 412, the UE 402 and the network node 404 may communicate monitoring distribution information. The monitoring distribution information may be associated with PDCCH monitoring in a multi-carrier mode. The multi-carrier mode may include a CA mode, a dual stack mode, and/or a DC mode. In some aspects, the monitoring distribution information may be indicative of at least one of a distribution of a plurality of blind decodes (BDs) or a distribution of a plurality of control channel elements (CCEs) associated with monitoring PDCCH candidates across a plurality of carriers.

In some aspects, communicating the monitoring distribution information includes the network node 404 transmitting, and the UE 402 receiving, the monitoring distribution information. In some aspects, the network node 404 may transmit, and the UE 402 may receive, the monitoring distribution information in association with the monitoring distribution information request communication and/or the distribution preference indication.

In some aspects, communicating the monitoring distribution information may include the UE 402 transmitting, and the network node 404 receiving, the monitoring distribution information. In some aspects, communicating the monitoring distribution information may include communicating a dynamic communication including the monitoring distribution information. In some aspects, communicating the monitoring distribution information may include communicating a semi-static communication including the monitoring distribution information.

In some aspects, the monitoring distribution information may include an implicit indication of the distribution. In some aspects, the implicit indication may be indicative of a scaling factor to be applied by the UE 402. In some aspects, the monitoring distribution information may include an explicit indication of the distribution. The explicit indication may be indicative of a quantity of the plurality of BDs and/or the plurality of CCEs. In some aspects, the monitoring distribution information may be associated with one or more component carriers, bands, SCSs, and/or frequency ranges, among other examples.

In some aspects, communicating the monitoring distribution information may include receiving the monitoring distribution information in association with the capability information. In some aspects, the monitoring distribution information may include a value of a PDCCH blind detection parameter, and the distribution may be associated with the value.

As shown in a fifth operation 414, the UE 402 may monitor the PDCCH candidates in accordance with the at least one of the distribution of the plurality of BDs or the distribution of the plurality CCEs. In some aspects, the distribution may be associated with a plurality of groups of carriers of the plurality of carriers. Monitoring the PDCCH may include monitoring a quantity of BDs and/or CCEs in association with a group of the plurality of groups of carriers, where the quantity is associated with the value. In some aspects, the value may include a total quantity of BDs and/or CCEs across the plurality of groups of carriers, and the quantity may include a per-group quantity. In some aspects, the per-group quantity may be associated with a scalar. In some aspects, the per-group quantity may be associated with one or more group-specific scalars, SCSs, processing timelines, frequency parameters, and/or time parameters, among other examples.

In some aspects, the distribution may be associated with a reference time window. In some aspects, the reference time window may include a slot duration associated with a carrier having a smallest SCS of a plurality of respective SCSs associated with the plurality of carriers. In some aspects, the distribution may be associated with at least one slot direction associated with the plurality of carriers. In some aspects, communicating the monitoring distribution information may include receiving a search space set group (SSSG) switching command, where the distribution may be associated with the SSSG switching command. In some cases, the multi-carrier mode may include a DC mode and the distribution may be associated with at least one cell group associated with the plurality of carriers.

In some aspects, the UE capability information may be indicative of a processing sharing capability, and the distribution may be associated with the processing sharing capability. In some aspects, the multi-carrier mode may be associated with a multi-transmission reception point (mTRP) configuration. The monitoring distribution information may be indicative of least one scaling weight associated with the mTRP configuration. In some aspects, the distribution may include at least one quantity of BDs and/or CCEs associated with at least one respective TRP of a set of TRPs associated with the mTRP configuration.

As shown in a sixth operation, the network node 404 may transmit, and the UE 402 may receive, DCI in accordance with the monitoring distribution information.

FIG. 5 is a flowchart illustrating an example process 500 performed, for example, at a UE or an apparatus of a UE that supports multi-carrier operations in accordance with the present disclosure. Example process 500 is an example where the apparatus or the UE (for example, UE 402) performs operations associated with monitoring distributions associated with PDCCH monitoring in multi-carrier operations.

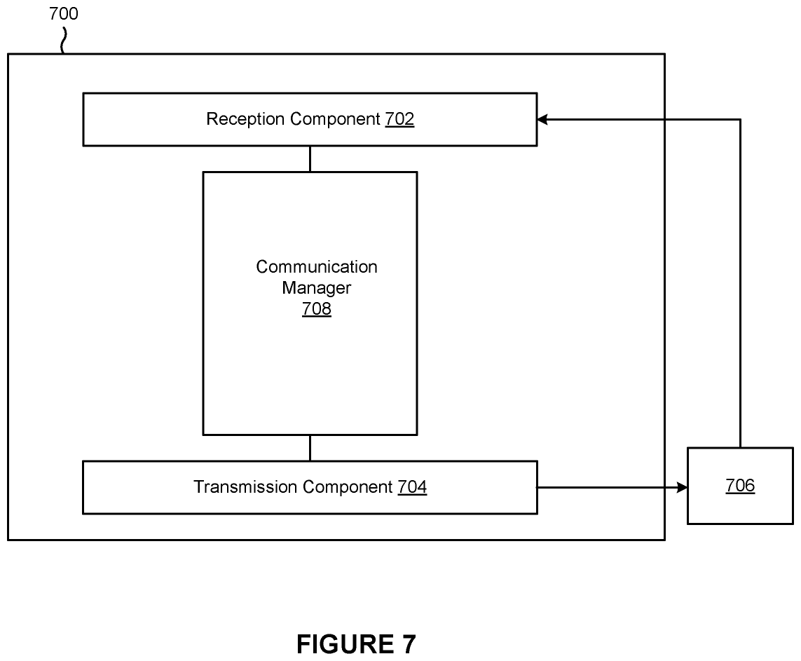

As shown in FIG. 5, in some aspects, process 500 may include communicating monitoring distribution information associated with PDCCH monitoring in a multi-carrier mode, the monitoring distribution information indicative of at least one of a distribution of a plurality of blind decodes (BDs) or a distribution of a plurality of control channel elements (CCEs) associated with monitoring PDCCH candidates across a plurality of carriers (block 510). For example, the UE (such as by using communication manager 708, reception component 702, or transmission component 704, depicted in FIG. 7) may communicate monitoring distribution information associated with PDCCH monitoring in a multi-carrier mode, the monitoring distribution information indicative of at least one of a distribution of a plurality of blind decodes (BDs) or a distribution of a plurality of control channel elements (CCEs) associated with monitoring PDCCH candidates across a plurality of carriers, as described above.

As further shown in FIG. 5, in some aspects, process 500 may include monitoring the PDCCH candidates in accordance with the at least one of the distribution of the plurality of BDs or the distribution of the plurality CCEs (block 520). For example, the UE (such as by using communication manager 708 or reception component 702, depicted in FIG. 7) may monitor the PDCCH candidates in accordance with the at least one of the distribution of the plurality of BDs or the distribution of the plurality CCEs, as described above.

Process 500 may include additional aspects, such as any single aspect or any combination of aspects described below or in connection with one or more other processes described elsewhere herein.

In a first additional aspect, the multi-carrier mode comprises a CA mode. In a second additional aspect, alone or in combination with the first aspect, the multi-carrier mode comprises a DC mode.

In a third additional aspect, alone or in combination with one or more of the first and second aspects, communicating the monitoring distribution information comprises receiving the monitoring distribution information from a network node. In a fourth additional aspect, alone or in combination with one or more of the first through third aspects, process 500 includes transmitting a monitoring distribution information request communication to the network node, wherein receiving the monitoring distribution information comprises receiving the monitoring distribution information in association with the monitoring distribution information request communication. In a fifth additional aspect, alone or in combination with one or more of the first through fourth aspects, process 500 includes transmitting a distribution preference indication to the network node, wherein receiving the monitoring distribution information comprises receiving the monitoring distribution information in association with the distribution preference indication. In a sixth additional aspect, alone or in combination with one or more of the first through fifth aspects, transmitting the distribution preference indication comprises transmitting UE assistance information including the distribution preference indication. In a seventh additional aspect, alone or in combination with one or more of the first through sixth aspects, communicating the monitoring distribution information comprises transmitting the monitoring distribution information to a network node.

In an eighth additional aspect, alone or in combination with one or more of the first through seventh aspects, communicating the monitoring distribution information comprises communicating a dynamic communication including the monitoring distribution information. In a ninth additional aspect, alone or in combination with one or more of the first through eighth aspects, communicating the monitoring distribution information comprises communicating a semi-static communication including the monitoring distribution information.

In a tenth additional aspect, alone or in combination with one or more of the first through ninth aspects, the monitoring distribution information comprises an implicit indication of the distribution. In an eleventh additional aspect, alone or in combination with one or more of the first through tenth aspects, the implicit indication is indicative of a scaling factor. In a twelfth additional aspect, alone or in combination with one or more of the first through eleventh aspects, the monitoring distribution information comprises an explicit indication of the distribution. In a thirteenth additional aspect, alone or in combination with one or more of the first through twelfth aspects, the explicit indication is indicative of a quantity of at least one of the plurality of BDs or the plurality of CCEs.

In a fourteenth additional aspect, alone or in combination with one or more of the first through thirteenth aspects, monitoring distribution information is associated with at least one of a plurality of component carriers, a plurality of bands, a plurality of subcarrier spacings, or a plurality of frequency ranges. In a fifteenth additional aspect, alone or in combination with one or more of the first through fourteenth aspects, process 500 includes transmitting capability information indicative of a UE capability associated with distributing at least one of the plurality of BDs or the plurality of CCEs across the plurality of carriers, wherein communicating the monitoring distribution information comprises receiving the monitoring distribution information in association with the capability information. In a sixteenth additional aspect, alone or in combination with one or more of the first through fifteenth aspects, the capability information indicates a total quantity of at least one of the plurality of BDs or the plurality of CCEs supported by the UE.

In a seventeenth additional aspect, alone or in combination with one or more of the first through sixteenth aspects, the total quantity is associated with at least one of a set of configured carriers, a subset of the set of configured carriers, a cell group, or a carrier of the set of configured carriers. In an eighteenth additional aspect, alone or in combination with one or more of the first through seventeenth aspects, the UE capability is associated with at least one of a plurality of component carriers, a plurality of bands, a plurality of subcarrier spacings, or a plurality of frequency ranges.

In a nineteenth additional aspect, alone or in combination with one or more of the first through eighteenth aspects, the monitoring distribution information comprises a value of a PDCCH blind detection parameter, and wherein the distribution is associated with the value.

In a twentieth additional aspect, alone or in combination with one or more of the first through nineteenth aspects, the distribution is associated with a plurality of groups of carriers of the plurality of carriers, and wherein monitoring the PDCCH candidates comprises monitoring the PDCCH candidates in association with a quantity of at least one of the plurality of BDs or the plurality of CCEs associated with a group of the plurality of groups of carriers, wherein the quantity is associated with the value. In a twenty-first additional aspect, alone or in combination with one or more of the first through twentieth aspects, the value comprises a total quantity of at least one of the plurality of BDs or the plurality of CCEs across the plurality of groups of carriers, and wherein the quantity comprises a per-group quantity. In a twenty-second additional aspect, alone or in combination with one or more of the first through twenty-first aspects, the per-group quantity is associated with a scalar. In a twenty-third additional aspect, alone or in combination with one or more of the first through twenty-second aspects, the per-group quantity is associated with at least one of a group-specific scalar, a subcarrier spacing, a processing timeline, a frequency parameter, or a time parameter.

In a twenty-fourth additional aspect, alone or in combination with one or more of the first through twenty-third aspects, the distribution is associated with a reference time window. In a twenty-fifth additional aspect, alone or in combination with one or more of the first through twenty-fourth aspects, the reference time window comprises a slot duration associated with a carrier having a smallest SCS of a plurality of respective SCSs associated with the plurality of carriers. In a twenty-sixth additional aspect, alone or in combination with one or more of the first through twenty-fifth aspects, the distribution is associated with at least one slot direction associated with the plurality of carriers.

In a twenty-seventh additional aspect, alone or in combination with one or more of the first through twenty-sixth aspects, communicating the monitoring distribution information comprises receiving an SSSG switching command, wherein the distribution is associated with the SSSG switching command. In a twenty-eighth additional aspect, alone or in combination with one or more of the first through twenty-seventh aspects, the multi-carrier mode comprises a DC mode and wherein the distribution is associated with at least one cell group associated with the plurality of carriers. In a twenty-ninth additional aspect, alone or in combination with one or more of the first through twenty-eighth aspects, process 500 includes transmitting UE capability information indicative of a processing sharing capability, wherein the distribution is associated with the processing sharing capability.

In a thirtieth additional aspect, alone or in combination with one or more of the first through twenty-ninth aspects, the multi-carrier mode is associated with an mTRP configuration. In a thirty-first additional aspect, alone or in combination with one or more of the first through thirtieth aspects, the monitoring distribution information is indicative of least one scaling weight associated with the mTRP configuration. In a thirty-second additional aspect, alone or in combination with one or more of the first through thirty-first aspects, the distribution comprises at least one quantity of at least one of the plurality of BDs or the plurality of CCEs associated with at least one respective TRP of a set of TRPs associated with the mTRP configuration.

Although FIG. 5 shows example blocks of process 500, in some aspects, process 500 may include additional blocks, fewer blocks, different blocks, or differently arranged blocks than those depicted in FIG. 5. Additionally or alternatively, two or more of the blocks of process 500 may be performed in parallel.

FIG. 6 is a flowchart illustrating an example process 600 performed, for example, at a network node or an apparatus of a network node that supports multi-carrier operations in accordance with the present disclosure. Example process 600 is an example where the apparatus or the network node (for example, network node 404) performs operations associated with monitoring distributions associated with PDCCH monitoring in multi-carrier operations.

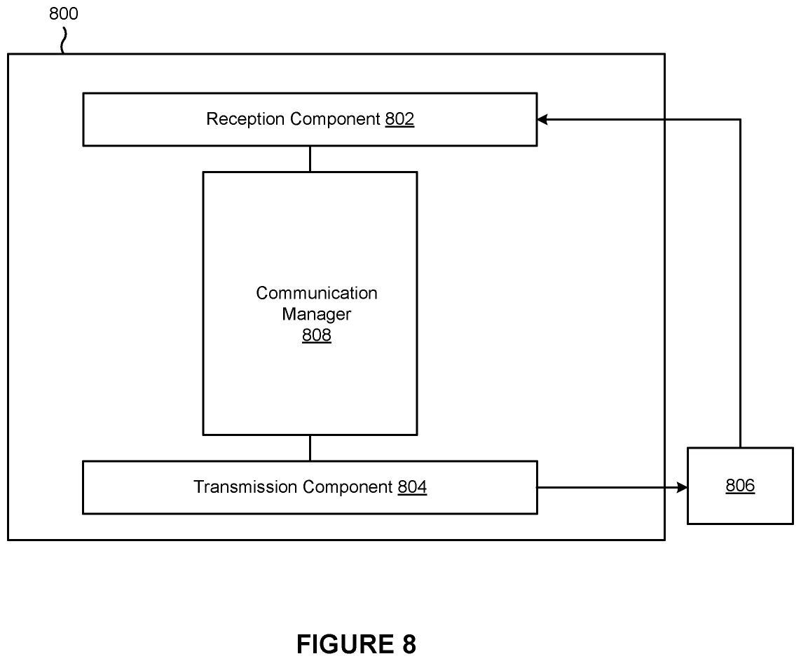

As shown in FIG. 6, in some aspects, process 600 may include communicating monitoring distribution information associated with PDCCH monitoring in a multi-carrier mode, the monitoring distribution information indicative of at least one of a distribution of a plurality of blind decodes (BDs) or a distribution of a plurality of control channel elements (CCEs) associated with monitoring PDCCH candidates across a plurality of carriers (block 610). For example, the network node (such as by using communication manager 808, reception component 802, or transmission component 804, depicted in FIG. 8) may communicate monitoring distribution information associated with PDCCH monitoring in a multi-carrier mode, the monitoring distribution information indicative of at least one of a distribution of a plurality of blind decodes (BDs) or a distribution of a plurality of control channel elements (CCEs) associated with monitoring PDCCH candidates across a plurality of carriers, as described above.

As further shown in FIG. 6, in some aspects, process 600 may include transmitting DCI in accordance with the monitoring distribution information (block 620). For example, the network node (such as by using communication manager 808 or transmission component 804, depicted in FIG. 8) may transmit DCI in accordance with the monitoring distribution information, as described above.

Process 600 may include additional aspects, such as any single aspect or any combination of aspects described below or in connection with one or more other processes described elsewhere herein.

In a first additional aspect, the multi-carrier mode comprises a CA mode. In a second additional aspect, alone or in combination with the first aspect, the multi-carrier mode comprises a DC mode.

In a third additional aspect, alone or in combination with one or more of the first and second aspects, communicating the monitoring distribution information comprises transmitting the monitoring distribution information to a UE. In a fourth additional aspect, alone or in combination with one or more of the first through third aspects, process 600 includes receiving a monitoring distribution information request communication from the UE, wherein transmitting the monitoring distribution information comprises transmitting the monitoring distribution information in association with the monitoring distribution information request communication. In a fifth additional aspect, alone or in combination with one or more of the first through fourth aspects, process 600 includes receiving a distribution preference indication from the UE, wherein transmitting the monitoring distribution information comprises transmitting the monitoring distribution information in association with the distribution preference indication. In a sixth additional aspect, alone or in combination with one or more of the first through fifth aspects, receiving the distribution preference indication comprises receiving UE assistance information including the distribution preference indication.

In a seventh additional aspect, alone or in combination with one or more of the first through sixth aspects, communicating the monitoring distribution information comprises receiving the monitoring distribution information from a UE.

In an eighth additional aspect, alone or in combination with one or more of the first through seventh aspects, communicating the monitoring distribution information comprises communicating a dynamic communication including the monitoring distribution information. In a ninth additional aspect, alone or in combination with one or more of the first through eighth aspects, communicating the monitoring distribution information comprises communicating a semi-static communication including the monitoring distribution information.

In a tenth additional aspect, alone or in combination with one or more of the first through ninth aspects, the monitoring distribution information comprises an implicit indication of the distribution. In an eleventh additional aspect, alone or in combination with one or more of the first through tenth aspects, the implicit indication is indicative of a scaling factor. In a twelfth additional aspect, alone or in combination with one or more of the first through eleventh aspects, the monitoring distribution information comprises an explicit indication of the distribution. In a thirteenth additional aspect, alone or in combination with one or more of the first through twelfth aspects, the explicit indication is indicative of a quantity of at least one of the plurality of BDs or the plurality of CCEs.

In a fourteenth additional aspect, alone or in combination with one or more of the first through thirteenth aspects, monitoring distribution information is associated with at least one of a plurality of component carriers, a plurality of bands, a plurality of subcarrier spacings, or a plurality of frequency ranges. In a fifteenth additional aspect, alone or in combination with one or more of the first through fourteenth aspects, process 600 includes receiving capability information indicative of a UE capability associated with distributing at least one of the plurality of BDs or the plurality of CCEs across the plurality of carriers, wherein communicating the monitoring distribution information comprises transmitting the monitoring distribution information in association with the capability information. In a sixteenth additional aspect, alone or in combination with one or more of the first through fifteenth aspects, the capability information indicates a total quantity of at least one of the plurality of BDs or the plurality of CCEs supported by the UE.

In a seventeenth additional aspect, alone or in combination with one or more of the first through sixteenth aspects, the total quantity is associated with at least one of a set of configured carriers, a subset of the set of configured carriers, a cell group, or a carrier of the set of configured carriers. In an eighteenth additional aspect, alone or in combination with one or more of the first through seventeenth aspects, the UE capability is associated with at least one of a plurality of component carriers, a plurality of bands, a plurality of subcarrier spacings, or a plurality of frequency ranges.

In a nineteenth additional aspect, alone or in combination with one or more of the first through eighteenth aspects, the monitoring distribution information comprises a value of a PDCCH blind detection parameter, and wherein the distribution is associated with the value.

In a twentieth additional aspect, alone or in combination with one or more of the first through nineteenth aspects, the distribution is associated with a plurality of groups of carriers of the plurality of carriers, and wherein a monitoring task associated with at least one of the plurality of BDs or the plurality of CCEs is associated with a quantity of the at least one of the plurality of BDs or the plurality of CCEs in association with a group of the plurality of groups of carriers, wherein the quantity is associated with the value. In a twenty-first additional aspect, alone or in combination with one or more of the first through twentieth aspects, the value comprises a total quantity of at least one of the plurality of BDs or the plurality of CCEs across the plurality of groups of carriers, and wherein the quantity comprises a per-group quantity. In a twenty-second additional aspect, alone or in combination with one or more of the first through twenty-first aspects, the per-group quantity is associated with a scalar. In a twenty-third additional aspect, alone or in combination with one or more of the first through twenty-second aspects, the per-group quantity is associated with at least one of a group-specific scalar, a subcarrier spacing, a processing timeline, a frequency parameter, or a time parameter.

In a twenty-fourth additional aspect, alone or in combination with one or more of the first through twenty-third aspects, the distribution is associated with a reference time window. In a twenty-fifth additional aspect, alone or in combination with one or more of the first through twenty-fourth aspects, the reference time window comprises a slot duration associated with a carrier having a smallest SCS of a plurality of respective SCSs associated with the plurality of carriers. In a twenty-sixth additional aspect, alone or in combination with one or more of the first through twenty-fifth aspects, the distribution is associated with at least one slot direction associated with the plurality of carriers.

In a twenty-seventh additional aspect, alone or in combination with one or more of the first through twenty-sixth aspects, communicating the monitoring distribution information comprises transmitting an SSSG switching command, wherein the distribution is associated with the SSSG switching command. In a twenty-eighth additional aspect, alone or in combination with one or more of the first through twenty-seventh aspects, the multi-carrier mode comprises a DC mode and wherein the distribution is associated with at least one cell group associated with the plurality of carriers. In a twenty-ninth additional aspect, alone or in combination with one or more of the first through twenty-eighth aspects, process 600 includes receiving UE capability information indicative of a processing sharing capability, wherein the distribution is associated with the processing sharing capability.

In a thirtieth additional aspect, alone or in combination with one or more of the first through twenty-ninth aspects, the multi-carrier mode is associated with an mTRP configuration. In a thirty-first additional aspect, alone or in combination with one or more of the first through thirtieth aspects, the monitoring distribution information is indicative of least one scaling weight associated with the mTRP configuration. In a thirty-second additional aspect, alone or in combination with one or more of the first through thirty-first aspects, the distribution comprises at least one quantity of at least one of the plurality of BDs or the plurality of CCEs associated with at least one respective TRP of a set of TRPs associated with the mTRP configuration.

Although FIG. 6 shows example blocks of process 600, in some aspects, process 600 may include additional blocks, fewer blocks, different blocks, or differently arranged blocks than those depicted in FIG. 6. Additionally or alternatively, two or more of the blocks of process 600 may be performed in parallel.

FIG. 7 is a diagram of an example apparatus 700 for wireless communication that supports multi-carrier operations in accordance with the present disclosure. The apparatus 700 may be a UE, or a UE may include the apparatus 700. In some aspects, the apparatus 700 includes a reception component 702, a transmission component 704, and a communication manager 708, which may be in communication with one another (for example, via one or more buses). As shown, the apparatus 700 may communicate with another apparatus 706 (such as a UE, a network node, or another wireless communication device) using the reception component 702 and the transmission component 704.

In some aspects, the apparatus 700 may be configured to and/or operable to perform one or more operations described herein in connection with FIG. 4. Additionally or alternatively, the apparatus 700 may be configured to and/or operable to perform one or more processes described herein, such as process 500 of FIG. 5. In some aspects, the apparatus 700 may include one or more components of the UE described above in connection with FIG. 2.

The reception component 702 may receive communications, such as reference signals, control information, and/or data communications, from the apparatus 706. The reception component 702 may provide received communications to one or more other components of the apparatus 700, such as the communication manager 140. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 702 may include one or more antennas, one or more modems, one or more demodulators, one or more MIMO detectors, one or more receive processors, one or more controllers/processors, and/or one or more memories of the UE described above in connection with FIG. 2.

The transmission component 704 may transmit communications, such as reference signals, control information, and/or data communications, to the apparatus 706. In some aspects, the communication manager 140 may generate communications and may transmit the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, one or more modems, one or more modulators, one or more transmit MIMO processors, one or more transmit processors, one or more controllers/processors, and/or one or more memories of the UE described above in connection with FIG. 2. In some aspects, the transmission component 704 may be co-located with the reception component 702 in one or more transceivers.

The communication manager 708 may communicate monitoring distribution information associated with PDCCH monitoring in a multi-carrier mode, the monitoring distribution information indicative of a distribution of at least one of a BD or a CCE across a plurality of carriers. The communication manager 708 may monitor the at least one of the BD or the CCE in association with the monitoring distribution information. In some aspects, the communication manager 708 may perform one or more operations described elsewhere herein as being performed by one or more components of the communication manager 140.

The communication manager 708 may include one or more controllers/processors and/or one or more memories of the UE described above in connection with FIG. 2. In some aspects, the communication manager 708 includes a set of components. Alternatively, the set of components may be separate and distinct from the communication manager 708. In some aspects, one or more components of the set of components may include or may be implemented within one or more controllers/processors and/or one or more memories of the UE described above in connection with FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The communication manager 708 and/or the transmission component 704 may communicate monitoring distribution information associated with PDCCH monitoring in a multi-carrier mode, the monitoring distribution information indicative of at least one of a distribution of a plurality of blind decodes (BDs) or a distribution of a plurality of control channel elements (CCEs) associated with monitoring PDCCH candidates across a plurality of carriers. The communication manager 708 and/or the reception component 702 may monitor the PDCCH candidates in accordance with the at least one of the distribution of the plurality of BDs or the distribution of the plurality CCEs.

The communication manager 708 and/or the transmission component 704 may transmit a monitoring distribution information request communication, wherein receiving the monitoring distribution information comprises receiving the monitoring distribution information in association with the monitoring distribution information request communication. The communication manager 708 and/or the transmission component 704 may transmit a distribution preference indication, wherein receiving the monitoring distribution information comprises receiving the monitoring distribution information in association with the distribution preference indication. The communication manager 708 and/or the transmission component 704 may transmit capability information indicative of a UE capability associated with distributing at least one of the plurality of BDs or the plurality of CCEs across the plurality of carriers, wherein communicating the monitoring distribution information comprises receiving the monitoring distribution information in association with the capability information. The communication manager 708 and/or the transmission component 704 may transmit UE capability information indicative of a processing sharing capability, wherein the distribution is associated with the processing sharing capability.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally or alternatively, a set of (one or more) components shown in FIG. 7 may perform one or more functions described as being performed by another set of components shown in FIG. 7.

FIG. 8 is a diagram of an example apparatus 800 for wireless communication that supports multi-carrier operations in accordance with the present disclosure. The apparatus 800 may be a network node, or a network node may include the apparatus 800. In some aspects, the apparatus 800 includes a reception component 802, a transmission component 804, and a communication manager 808, which may be in communication with one another (for example, via one or more buses). As shown, the apparatus 800 may communicate with another apparatus 806 (such as a UE, a network node, or another wireless communication device) using the reception component 802 and the transmission component 804.

In some aspects, the apparatus 800 may be configured to and/or operable to perform one or more operations described herein in connection with FIG. 4. Additionally or alternatively, the apparatus 800 may be configured to and/or operable to perform one or more processes described herein, such as process 600 of FIG. 6. In some aspects, the apparatus 800 may include one or more components of the network node described above in connection with FIG. 2.

The reception component 802 may receive communications, such as reference signals, control information, and/or data communications, from the apparatus 806. The reception component 802 may provide received communications to one or more other components of the apparatus 800, such as the communication manager 150. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 802 may include one or more antennas, one or more modems, one or more demodulators, one or more MIMO detectors, one or more receive processors, one or more controllers/processors, and/or one or more memories of the network node described above in connection with FIG. 2.

The transmission component 804 may transmit communications, such as reference signals, control information, and/or data communications, to the apparatus 806. In some aspects, the communication manager 150 may generate communications and may transmit the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, one or more modems, one or more modulators, one or more transmit MIMO processors, one or more transmit processors, one or more controllers/processors, and/or one or more memories of the network node described above in connection with FIG. 2. In some aspects, the transmission component 804 may be co-located with the reception component 802 in one or more transceivers.

The communication manager 808 may communicate monitoring distribution information associated with PDCCH monitoring in a multi-carrier mode, the monitoring distribution information indicative of a distribution of at least one of a BD or a CCE across a plurality of carriers. The communication manager 808 may transmit or may cause the transmission component 804 to transmit DCI in the at least one of the BD or the CCE in association with the monitoring distribution information. In some aspects, the communication manager 808 may perform one or more operations described elsewhere herein as being performed by one or more components of the communication manager 808.

The communication manager 808 may include one or more controllers/processors, one or more memories, one or more schedulers, and/or one or more communication units of the network node described above in connection with FIG. 2. In some aspects, the communication manager 808 includes a set of components. Alternatively, the set of components may be separate and distinct from the communication manager 808. In some aspects, one or more components of the set of components may include or may be implemented within one or more controllers/processors, one or more memories, one or more schedulers, and/or one or more communication units of the network node described above in connection with FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The communication manager 808, reception component 802, and/or transmission component 804 may communicate monitoring distribution information associated with PDCCH monitoring in a multi-carrier mode, the monitoring distribution information indicative of at least one of a distribution of a plurality of blind decodes (BDs) or a distribution of a plurality of control channel elements (CCEs) associated with monitoring PDCCH candidates across a plurality of carriers. The transmission component 804 may transmit DCI in accordance with the monitoring distribution information.

The communication manager 808 and/or the reception component 802 may receive a monitoring distribution information request communication, wherein transmitting the monitoring distribution information comprises transmitting the monitoring distribution information in association with the monitoring distribution information request communication. The communication manager 808 and/or the reception component 802 may receive a distribution preference indication, wherein transmitting the monitoring distribution information comprises transmitting the monitoring distribution information in association with the distribution preference indication. The communication manager 808 and/or the reception component 802 may receive capability information indicative of a UE capability associated with distributing at least one of the plurality of BDs or the plurality of CCEs across the plurality of carriers, wherein communicating the monitoring distribution information comprises transmitting the monitoring distribution information in association with the capability information. The communication manager 808 and/or the reception component 802 may receive UE capability information indicative of a processing sharing capability, wherein the distribution is associated with the processing sharing capability.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally or alternatively, a set of (one or more) components shown in FIG. 8 may perform one or more functions described as being performed by another set of components shown in FIG. 8.

The following provides an overview of some Aspects of the present disclosure:
Aspect 1: A method for wireless communication by a user equipment (UE), comprising: communicating monitoring distribution information associated with physical downlink control channel (PDCCH) monitoring in a multi-carrier mode, the monitoring distribution information indicative of at least one of a distribution of a plurality of blind decodes (BDs) or a distribution of a plurality of control channel elements (CCEs) associated with monitoring PDCCH candidates across a plurality of carriers; and monitoring the PDCCH candidates in accordance with the at least one of the distribution of the plurality of BDs or the distribution of the plurality CCEs.
Aspect 2: The method of Aspect 1, wherein the multi-carrier mode comprises a carrier aggregation mode.
Aspect 3: The method of either of claim 1 or 2, wherein the multi-carrier mode comprises a dual connectivity mode or a dual stack mode.
Aspect 4: The method of any of Aspects 1-3, wherein communicating the monitoring distribution information comprises receiving the monitoring distribution information from a network node.
Aspect 5: The method of Aspect 4, further comprising transmitting a monitoring distribution information request communication to the network node, wherein receiving the monitoring distribution information comprises receiving the monitoring distribution information in association with the monitoring distribution information request communication.
Aspect 6: The method of either of claim 4 or 5, further comprising transmitting a distribution preference indication to the network node, wherein receiving the monitoring distribution information comprises receiving the monitoring distribution information in association with the distribution preference indication.
Aspect 7: The method of Aspect 6, wherein transmitting the distribution preference indication comprises transmitting UE assistance information including the distribution preference indication.
Aspect 8: The method of any of Aspects 1-7, wherein communicating the monitoring distribution information comprises transmitting the monitoring distribution information to a network node.
Aspect 9: The method of any of Aspects 1-8, wherein communicating the monitoring distribution information comprises communicating a dynamic communication including the monitoring distribution information.
Aspect 10: The method of any of Aspects 1-9, wherein communicating the monitoring distribution information comprises communicating a semi-static communication including the monitoring distribution information.
Aspect 11: The method of any of Aspects 1-10, wherein the monitoring distribution information comprises an implicit indication of the distribution.
Aspect 12: The method of Aspect 11, wherein the implicit indication is indicative of a scaling factor.
Aspect 13: The method of any of Aspects 1-12, wherein the monitoring distribution information comprises an explicit indication of the distribution.
Aspect 14: The method of Aspect 13, wherein the explicit indication is indicative of a quantity of at least one of the plurality of BDs or the plurality of CCEs.
Aspect 15: The method of any of Aspects 1-14, wherein monitoring distribution information is associated with at least one of a plurality of component carriers, a plurality of bands, a plurality of subcarrier spacings, or a plurality of frequency ranges.
Aspect 16: The method of any of Aspects 1-15, further comprising transmitting capability information indicative of a UE capability associated with distributing at least one of the plurality of BDs or the plurality of CCEs across the plurality of carriers, wherein communicating the monitoring distribution information comprises receiving the monitoring distribution information in association with the capability information.
Aspect 17: The method of Aspect 16, wherein the capability information indicates a total quantity of at least one of the plurality of BDs or the plurality of CCEs supported by the UE.
Aspect 18: The method of Aspect 17, wherein the total quantity is associated with at least one of a set of configured carriers, a subset of the set of configured carriers, a cell group, or a carrier of the set of configured carriers.
Aspect 19: The method of any of Aspects 16-18, wherein the UE capability is associated with at least one of a plurality of component carriers, a plurality of bands, a plurality of subcarrier spacings, or a plurality of frequency ranges.
Aspect 20: The method of any of Aspects 1-19, wherein the monitoring distribution information comprises a value of a PDCCH blind detection parameter, and wherein the distribution is associated with the value.
Aspect 21: The method of Aspect 20, wherein the distribution is associated with a plurality of groups of carriers of the plurality of carriers, and wherein monitoring the PDCCH candidates comprises monitoring the PDCCH candidates in association with a quantity of at least one of the plurality of BDs or the plurality of CCEs associated with a group of the plurality of groups of carriers, wherein the quantity is associated with the value.
Aspect 22: The method of Aspect 21, wherein the value comprises a total quantity of the least one of the plurality of BDs or the plurality of CCEs across the plurality of groups of carriers, and wherein the quantity comprises a per-group quantity.
Aspect 23: The method of Aspect 22, wherein the per-group quantity is associated with a scalar.
Aspect 24: The method of either of Aspects 22 or 23, wherein the per-group quantity is associated with at least one of a group-specific scalar, a subcarrier spacing, a processing timeline, a frequency parameter, or a time parameter.
Aspect 25: The method of any of Aspects 1-24, wherein the distribution is associated with a reference time window.
Aspect 26: The method of Aspect 25, wherein the reference time window comprises a slot duration associated with a carrier having a smallest subcarrier spacing (SCS) of a plurality of respective SCSs associated with the plurality of carriers.
Aspect 27: The method of any of Aspects 1-26, wherein the distribution is associated with at least one slot direction associated with the plurality of carriers.
Aspect 28: The method of any of Aspects 1-27, wherein communicating the monitoring distribution information comprises receiving a search space set group (SSSG) switching command, wherein the distribution is associated with the SSSG switching command.
Aspect 29: The method of any of Aspects 1-28, wherein the multi-carrier mode comprises a dual connectivity mode and wherein the distribution is associated with at least one cell group associated with the plurality of carriers.
Aspect 30: The method of Aspect 29, further comprising transmitting UE capability information indicative of a processing sharing capability, wherein the distribution is associated with the processing sharing capability.
Aspect 31: The method of any of Aspects 1-30, wherein the multi-carrier mode is associated with a multi-transmission reception point (mTRP) configuration.
Aspect 32: The method of Aspect 31, wherein the monitoring distribution information is indicative of least one scaling weight associated with the mTRP configuration.
Aspect 33: The method of either of claim 31 or 32, wherein the distribution comprises at least one quantity of at least one of the plurality of BDs or the plurality of CCEs associated with at least one respective TRP of a set of TRPs associated with the mTRP configuration.
Aspect 34: A method of wireless communication performed by a network node, comprising: communicating monitoring distribution information associated with physical downlink control channel (PDCCH) monitoring in a multi-carrier mode, the monitoring distribution information indicative of at least one of a distribution of a plurality of blind decodes (BDs) or a distribution of a plurality of control channel elements (CCEs) associated with monitoring PDCCH candidates across a plurality of carriers; and transmitting downlink control information (DCI) in accordance with the monitoring distribution information.
Aspect 35: The method of Aspect 34, wherein the multi-carrier mode comprises a carrier aggregation mode.
Aspect 36: The method of either of claim 34 or 35, wherein the multi-carrier mode comprises a dual connectivity mode or a dual stack mode.
Aspect 37: The method of any of Aspects 34-36, wherein communicating the monitoring distribution information comprises transmitting the monitoring distribution information to a user equipment (UE).
Aspect 38: The method of Aspect 37, further comprising receiving a monitoring distribution information request communication from the UE, wherein transmitting the monitoring distribution information comprises transmitting the monitoring distribution information in association with the monitoring distribution information request communication.
Aspect 39: The method of either of claim 37 or 38, further comprising receiving a distribution preference indication from the UE, wherein transmitting the monitoring distribution information comprises transmitting the monitoring distribution information in association with the distribution preference indication.
Aspect 40: The method of Aspect 39, wherein receiving the distribution preference indication comprises receiving UE assistance information including the distribution preference indication.
Aspect 41: The method of any of Aspects 34-40, wherein communicating the monitoring distribution information comprises receiving the monitoring distribution information from a user equipment (UE).
Aspect 42: The method of any of Aspects 34-41, wherein communicating the monitoring distribution information comprises communicating a dynamic communication including the monitoring distribution information.
Aspect 43: The method of any of Aspects 34-42, wherein communicating the monitoring distribution information comprises communicating a semi-static communication including the monitoring distribution information.
Aspect 44: The method of any of Aspects 34-43, wherein the monitoring distribution information comprises an implicit indication of the distribution.
Aspect 45: The method of Aspect 44, wherein the implicit indication is indicative of a scaling factor.
Aspect 46: The method of any of Aspects 34-45, wherein the monitoring distribution information comprises an explicit indication of the distribution.
Aspect 47: The method of Aspect 46, wherein the explicit indication is indicative of a quantity of at least one of the plurality of BDs or the plurality of CCEs.
Aspect 48: The method of any of Aspects 34-47, wherein monitoring distribution information is associated with at least one of a plurality of component carriers, a plurality of bands, a plurality of subcarrier spacings, or a plurality of frequency ranges.
Aspect 49: The method of any of Aspects 34-48, further comprising receiving capability information indicative of a UE capability associated with distributing at least one of the plurality of BDs or the plurality of CCEs across the plurality of carriers, wherein communicating the monitoring distribution information comprises transmitting the monitoring distribution information in association with the capability information.
Aspect 50: The method of Aspect 49, wherein the capability information indicates a total quantity of at least one of the plurality of BDs or the plurality of CCEs supported by the UE.
Aspect 51: The method of Aspect 50, wherein the total quantity is associated with at least one of a set of configured carriers, a subset of the set of configured carriers, a cell group, or a carrier of the set of configured carriers.
Aspect 52: The method of any of Aspects 49-51, wherein the UE capability is associated with at least one of a plurality of component carriers, a plurality of bands, a plurality of subcarrier spacings, or a plurality of frequency ranges.
Aspect 53: The method of any of Aspects 34-52, wherein the monitoring distribution information comprises a value of a PDCCH blind detection parameter, and wherein the distribution is associated with the value.
Aspect 54: The method of Aspect 53, wherein the distribution is associated with a plurality of groups of carriers of the plurality of carriers, and wherein a monitoring task associated with at least one of the plurality of BDs or the plurality of CCEs is associated with a quantity of the at least one of the plurality of BDs or the plurality of CCEs in association with a group of the plurality of groups of carriers, wherein the quantity is associated with the value.
Aspect 55: The method of Aspect 54, wherein the value comprises a total quantity of the at least one of the plurality of BDs or the plurality of CCEs across the plurality of groups of carriers, and wherein the quantity comprises a per-group quantity.
Aspect 56: The method of Aspect 55, wherein the per-group quantity is associated with a scalar.
Aspect 57: The method of either of Aspects 55 or 56, wherein the per-group quantity is associated with at least one of a group-specific scalar, a subcarrier spacing, a processing timeline, a frequency parameter, or a time parameter.
Aspect 58: The method of any of Aspects 34-57, wherein the distribution is associated with a reference time window.
Aspect 59: The method of Aspect 58, wherein the reference time window comprises a slot duration associated with a carrier having a smallest subcarrier spacing (SCS) of a plurality of respective SCSs associated with the plurality of carriers.
Aspect 60: The method of any of Aspects 34-59, wherein the distribution is associated with at least one slot direction associated with the plurality of carriers.
Aspect 61: The method of any of Aspects 34-60, wherein communicating the monitoring distribution information comprises transmitting a search space set group (SSSG) switching command, wherein the distribution is associated with the SSSG switching command.
Aspect 62: The method of any of Aspects 34-61, wherein the multi-carrier mode comprises a dual connectivity mode and wherein the distribution is associated with at least one cell group associated with the plurality of carriers.
Aspect 63: The method of Aspect 62, further comprising receiving UE capability information indicative of a processing sharing capability, wherein the distribution is associated with the processing sharing capability.
Aspect 64: The method of any of Aspects 34-63, wherein the multi-carrier mode is associated with a multi-transmission reception point (mTRP) configuration.
Aspect 65: The method of Aspect 64, wherein the monitoring distribution information is indicative of least one scaling weight associated with the mTRP configuration.
Aspect 66: The method of either of claim 64 or 65, wherein the distribution comprises at least one quantity of at least one of the plurality of BDs or the plurality of CCEs associated with at least one respective TRP of a set of TRPs associated with the mTRP configuration.
Aspect 67: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-33.
Aspect 68: An apparatus for wireless communication at a device, the apparatus comprising one or more memories and one or more processors coupled to the one or more memories, the one or more processors configured to cause the device to perform the method of one or more of Aspects 1-33.
Aspect 69: An apparatus for wireless communication, the apparatus comprising at least one means for performing the method of one or more of Aspects 1-33.
Aspect 70: A non-transitory computer-readable medium storing code for wireless communication, the code comprising instructions executable by one or more processors to perform the method of one or more of Aspects 1-33.
Aspect 71: A non-transitory computer-readable medium storing a set of instructions for wireless communication, the set of instructions comprising one or more instructions that, when executed by one or more processors of a device, cause the device to perform the method of one or more of Aspects 1-33.
Aspect 72: A device for wireless communication, the device comprising a processing system that includes one or more processors and one or more memories coupled with the one or more processors, the processing system configured to cause the device to perform the method of one or more of Aspects 1-33.
Aspect 73: An apparatus for wireless communication at a device, the apparatus comprising one or more memories and one or more processors coupled to the one or more memories, the one or more processors individually or collectively configured to cause the device to perform the method of one or more of Aspects 1-33.
Aspect 74: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 34-66.
Aspect 75: An apparatus for wireless communication at a device, the apparatus comprising one or more memories and one or more processors coupled to the one or more memories, the one or more processors configured to cause the device to perform the method of one or more of Aspects 34-66.
Aspect 76: An apparatus for wireless communication, the apparatus comprising at least one means for performing the method of one or more of Aspects 34-66.
Aspect 77: A non-transitory computer-readable medium storing code for wireless communication, the code comprising instructions executable by one or more processors to perform the method of one or more of Aspects 34-66.
Aspect 78: A non-transitory computer-readable medium storing a set of instructions for wireless communication, the set of instructions comprising one or more instructions that, when executed by one or more processors of a device, cause the device to perform the method of one or more of Aspects 34-66.
Aspect 79: A device for wireless communication, the device comprising a processing system that includes one or more processors and one or more memories coupled with the one or more processors, the processing system configured to cause the device to perform the method of one or more of Aspects 34-66.
Aspect 80: An apparatus for wireless communication at a device, the apparatus comprising one or more memories and one or more processors coupled to the one or more memories, the one or more processors individually or collectively configured to cause the device to perform the method of one or more of Aspects 34-66.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
a processing system that includes one or more processors and one or more memories coupled with the one or more processors, the processing system configured to cause the UE to:
communicate monitoring distribution information associated with physical downlink control channel (PDCCH) monitoring in a multi-carrier mode, the monitoring distribution information indicative of at least one of a distribution of a plurality of blind decodes (BDs) or a distribution of a plurality of control channel elements (CCEs) associated with monitoring PDCCH candidates across a plurality of carriers; and
monitor the PDCCH candidates in accordance with the at least one of the distribution of the plurality of BDs or the distribution of the plurality CCEs.

2. The UE of claim 1, wherein the multi-carrier mode comprises at least one of a carrier aggregation mode, a dual connectivity mode, or a dual stack mode.

3. The UE of claim 1, wherein, to cause the UE to communicate the monitoring distribution information, the processing system is configured to cause the UE to receive the monitoring distribution information from a network node.

4. The UE of claim 3, wherein the processing system is further configured to cause the UE to transmit a monitoring distribution information request communication to the network node, and wherein, to cause the UE to receive the monitoring distribution information, the processing system is configured to cause the UE to receive the monitoring distribution information in association with the monitoring distribution information request communication.

5. The UE of claim 3, wherein the processing system is further configured to cause the UE to transmit a distribution preference indication to the network node, and wherein, to cause the UE to receive the monitoring distribution information, the processing system is configured to cause the UE to receive the monitoring distribution information in association with the distribution preference indication.

6. The UE of claim 5, wherein, to cause the UE to transmit the distribution preference indication to the network node, the processing system is configured to cause the UE to transmit UE assistance information including the distribution preference indication.

7. The UE of claim 1, wherein, to cause the UE to communicate the monitoring distribution information, the processing system is configured to cause the UE to transmit the monitoring distribution information to a network node.

8. The UE of claim 1, wherein, to cause the UE to communicate the monitoring distribution information, the processing system is configured to cause the UE to communicate a dynamic communication including the monitoring distribution information.

9. The UE of claim 1, wherein, to cause the UE to communicate the monitoring distribution information, the processing system is configured to cause the UE to communicate a semi-static communication including the monitoring distribution information.

10. The UE of claim 1, wherein the monitoring distribution information comprises an implicit indication of the distribution.

11. The UE of claim 1, wherein the monitoring distribution information comprises an explicit indication of the distribution, and wherein the explicit indication is indicative of a quantity of at least one of the plurality of BDs or the plurality of CCEs.

12. The UE of claim 1, wherein the monitoring distribution information is associated with at least one of a plurality of component carriers, a plurality of bands, a plurality of subcarrier spacings, or a plurality of frequency ranges.

13. The UE of claim 1, wherein the processing system is further configured to cause the UE to transmit capability information indicative of a UE capability associated with distributing at least one of the plurality of BDs or the plurality of CCEs across the plurality of carriers, and wherein, to cause the UE to communicate the monitoring distribution information, the processing system is configured to cause the UE to receive the monitoring distribution information in association with the capability information, wherein the capability information indicates a total quantity of the at least one of the plurality of BDs or the plurality of CCEs supported by the UE.

14. The UE of claim 13, wherein the UE capability is associated with at least one of a plurality of component carriers, a plurality of bands, a plurality of subcarrier spacings, or a plurality of frequency ranges.

15. The UE of claim 1, wherein the monitoring distribution information comprises a value of a PDCCH blind detection parameter, and wherein the distribution is associated with the value.

16. The UE of claim 15, wherein the distribution is associated with a plurality of groups of carriers of the plurality of carriers, and wherein, to cause the UE to monitor the PDCCH candidates, the processing system is configured to cause the UE to monitor the PDCCH candidates in association with a quantity of at least one of the plurality of BDs or the plurality of CCEs associated with a group of the plurality of groups of carriers, wherein the quantity is associated with the value.

17. The UE of claim 16, wherein the value comprises a total quantity of the least one of the plurality of BDs or the plurality of CCEs across the plurality of groups of carriers, and wherein the quantity comprises a per-group quantity, wherein the per-group quantity is associated with at least one of a group-specific scalar, a subcarrier spacing, a processing timeline, a frequency parameter, or a time parameter.

18. The UE of claim 1, wherein the distribution is associated with a reference time window comprising a slot duration associated with a carrier having a smallest subcarrier spacing (SCS) of a plurality of respective (SCSs) associated with the plurality of carriers.

19. The UE of claim 1, wherein the distribution is associated with at least one slot direction associated with the plurality of carriers.

20. The UE of claim 1, wherein, to cause the UE to communicate the monitoring distribution information, the processing system is configured to cause the UE to receive a search space set group (SSSG) switching command, wherein the distribution is associated with the SSSG switching command.

21. The UE of claim 1, wherein the multi-carrier mode comprises a dual connectivity mode and wherein the distribution is associated with at least one cell group associated with the plurality of carriers.

22. The UE of claim 1, wherein the multi-carrier mode is associated with a multi-transmission reception point (mTRP) configuration, and wherein the distribution comprises at least one quantity of at least one of the plurality of BDs or the plurality of CCEs associated with at least one respective TRP of a set of TRPs associated with the mTRP configuration.

23. A network node for wireless communication, comprising:
a processing system that includes one or more processors and one or more memories coupled with the one or more processors, the processing system configured to cause the network node to:
communicate monitoring distribution information associated with physical downlink control channel (PDCCH) monitoring in a multi-carrier mode, the monitoring distribution information indicative of at least one of a distribution of a plurality of blind decodes (BDs) or a distribution of a plurality of control channel elements (CCEs) associated with monitoring PDCCH candidates across a plurality of carriers; and
transmit downlink control information (DCI) in accordance with the monitoring distribution information.

24. The network node of claim 23, wherein the multi-carrier mode comprises at least one of a carrier aggregation mode, a dual connectivity mode, or a dual stack mode.

25. A method for wireless communication by a user equipment (UE), comprising:
communicating monitoring distribution information associated with physical downlink control channel (PDCCH) monitoring in a multi-carrier mode, the monitoring distribution information indicative of at least one of a distribution of a plurality of blind decodes (BDs) or a distribution of a plurality of control channel elements (CCEs) associated with monitoring PDCCH candidates across a plurality of carriers; and
monitoring the PDCCH candidates in accordance with the at least one of the distribution of the plurality of BDs or the distribution of the plurality CCEs.

26. The method of claim 25, wherein the multi-carrier mode comprises at least one of a carrier aggregation mode or a dual connectivity mode.

27. The method of claim 25, wherein the monitoring distribution information is associated with at least one of a plurality of component carriers, a plurality of bands, a plurality of subcarrier spacings, or a plurality of frequency ranges.

28. A method of wireless communication by a network node, comprising:
communicating monitoring distribution information associated with physical downlink control channel (PDCCH) monitoring in a multi-carrier mode, the monitoring distribution information indicative of at least one of a distribution of a plurality of blind decodes (BDs) or a distribution of a plurality of control channel elements (CCEs) associated with monitoring PDCCH candidates across a plurality of carriers; and
transmitting downlink control information (DCI) in accordance with the monitoring distribution information.

29. The method of claim 28, wherein the multi-carrier mode comprises at least one of a carrier aggregation mode or a dual connectivity mode.

30. The method of claim 28, wherein the monitoring distribution information is associated with at least one of a plurality of component carriers, a plurality of bands, a plurality of subcarrier spacings, or a plurality of frequency ranges.
